(19) United States
(12) Patent Application Publication
(10) Pub. No.: US 2022/0397689 A1
(43) Pub. Date: Dec. 15, 2022

(54) METHOD FOR EXTENDING LIFESPAN OF RHODIUM MEASURING DEVICES

(71) Applicants: Choon Sung YOO, Daejeon (KR); Sung Hoon YOO, Daejeon (KR)

(72) Inventors: Choon Sung YOO, Daejeon (KR); Sung Hoon YOO, Daejeon (KR)

(21) Appl. No.: 17/777,028

(22) PCT Filed: Nov. 5, 2020
(86) PCT No.: PCT/KR2020/015367

§ 371 Date: May 14, 2022

(30) Foreign Application Priority Data
Nov. 15, 2019 (KR) 10-2019-0146527

(51) Int. Cl. G01T 3/00; G21C 17/108

(52) U.S. Cl. CPC G01T 3/00; G21C 17/108

(57) ABSTRACT

The present invention relates to a method for extending the lifespan of rhodium measuring devices. To this end, the method comprises the steps of: measuring current signals, expressed in amperes, which are induced by electrons emitted as a result of rhodium, in each rhodium measuring device, undergoing beta decay as a result of absorbing neutrons (S10); on the basis of the current signals, and by using a CECOR program, calculating, for each rhodium burnup, respective positional output values of the individual rhodium measuring devices (S20); calculating, for each rhodium burnup, an optimal output value for all positions (S30); determining a W′ correction constant, or a change in an exponent of an approximate expression of the sensitivity of the rhodium measuring devices (S40); calculating, for each rhodium burnup, respective positional output values of the individual rhodium measuring devices, and checking same by carrying out a comparative analysis between same and the respective positional output values of the rhodium measuring devices, calculated in S20 (S50); and extending the lifespan of usage of the rhodium measuring devices by applying the W′ correction constant, or the exponent of the approximate expression of sensitivity, at the time point when ⅔ or more of the rhodium in the rhodium measuring devices is burned up (S60).

### TECHNICAL FIELD

The present invention relates to a method for extending lifespans of rhodium measuring devices arranged in a height direction of a nuclear fuel assembly, and more particularly, to a method for extending lifespans of rhodium measuring devices, in which a change in a W′ correction constant or a change in an exponent of an approximate expression of sensitivity according to an increase in an accumulated charge amount is subject to tracking calculation so as to be applied to individual positions of the rhodium measuring devices, so that the rhodium measuring device is able to be continuously used even when sensitivity of the rhodium measuring device becomes less than or equal to ⅓ of initial sensitivity (⅔ or more of rhodium is burned up).

### BACKGROUND ART

The most important part of a nuclear power plant is a reactor core, which is referred to as a nuclear reactor core. Enormous heat may be generated by nuclear fission of a nuclear fuel loaded in the reactor core, and electricity may be generated by increasing a temperature of water (coolant) by using the heat, generating steam through heat exchange in a steam generator, and turning a turbine by the steam.

The nuclear fission may basically occur as neutrons are absorbed into the nuclear fuel, and since excess neutrons are generated again simultaneously with the nuclear fission, continuous nuclear fission may be maintained. Therefore, a thermal power of the nuclear reactor core may be determined by the number of neutrons present in the reactor core.

The power of the nuclear reactor core is the most important factor for safety of a nuclear reactor, and it is strictly forbidden to increase the power above a specific power determined in a design process. An increase in the power above a design power may cause damage to the nuclear fuel, and a coolant in the nuclear reactor may boil to generate bubbles when the power increases above a cooling capacity of a coolant, which may also cause the damage to the nuclear fuel as well as an increase in a pressure inside the nuclear reactor, so that the nuclear reactor may reach a very dangerous state.

In addition, even when an overall power of the nuclear reactor is the same, a similar risk may also exist in a case where a power of a specific position of the nuclear reactor is locally increased according to a change in power distribution, so that it is also very important to continuously monitor the change in the power distribution.

In a case of Korean standard and optimized power reactor-1000 (OPR-1000) nuclear power plants, 177 nuclear fuel assemblies having one side length of about 20 centimeters and a height of about 4 meters are loaded, and the nuclear fuel is replaced once a year to a year and six months, in which about ⅓ of the nuclear fuel is replaced at each replacement. Some of neutrons generated from the nuclear fuel may be absorbed back into an adjacent nuclear fuel so as to contribute to nuclear fission, while some of the neutrons may not be absorbed into the nuclear fuel so as to leak out of the nuclear reactor.

Therefore, under the same conditions, many neutrons may be concentrated at a center of the reactor core so as to cause a high power at the center of the reactor, and the nuclear fuel positioned at an outer periphery of the reactor core may have a low power because the outer periphery of the reactor core is a disadvantageous position for the nuclear fission due to many neutrons leaking out. As described above, since the power varies for each nuclear fuel loading position, while it is important to monitor the overall power of the nuclear reactor, it is also very important to monitor power distribution for each nuclear fuel assembly. In addition, since a height of the nuclear fuel is about 4 meters, power distribution in an axial direction may also vary continuously during operation, so that the power distribution in the axial direction may also be an important monitoring target.

Since the nuclear fuel is loaded in a ¼ reactor core symmetrical structure and burned up inside the nuclear reactor, during the design process, unless there is a special occasion, only one quadrant of a ¼ reactor core may be evaluated, and the remaining three quadrants of the ¼ reactor core may be considered to have the same evaluation result due to symmetry. However, in actual monitoring of the power plant, safety is continuously checked while monitoring all of the four quadrants.

In this case, since the number of rhodium atoms in the rhodium measuring devices (Korean Patent Registration No. 1562630) for checking safety is continuously reduced because rhodium is burned up according to absorption of neutrons, a magnitude of a current signal may gradually decrease even in the same neutron environment.

Therefore, in order to compensate for the above phenomenon, sensitivity may be defined to compensate for the burning of the rhodium.

However, in order to accurately measure the sensitivity according to the burning of the rhodium, it may be necessary to continuously measure the current signal according to the burning of the rhodium until the rhodium is completely burned up in a constant neutron environment in an experimental or research reactor.

However, since it is impossible to perform an experiment while constantly maintaining the number of the neutrons and energy distribution for a long time, the sensitivity has been predicted by an approximate scheme according to the related art.

The sensitivity is linearly and inversely proportional to an accumulated charge amount. In other words, since the sensitivity linearly decreases according to the burning of the rhodium, the linear and inverse proportion is valid until a time point when a remaining amount of the rhodium becomes ⅓ of an initial amount, and replacement has to be performed after the time point, the replacement has been a very big problem in terms of a cost and disposal of radioactive waste.

In particular, since it is impossible to replace the rhodium measuring device while the nuclear reactor is operating, a rhodium measuring device, which is predicted to have sensitivity that is less than or equal to ⅓ of initial sensitivity at an end of a next operation cycle, has to be replaced in advance during a maintenance period before start of an operation of the next cycle, so that the rhodium measuring device has been actually replaced much before the time point at which the ⅓ is reached, which is a very heavy burden on the power plant.

### DETAILED DESCRIPTION OF THE INVENTION

### Technical Problem

The present invention has been devised in view of the above problems, and an object of the present invention is to provide a method for extending lifespans of rhodium measuring devices, in which a change in a W′ correction constant or a change in an exponent of an approximate expression of sensitivity according to an increase in an accumulated charge amount is subject to tracking calculation so as to be individually applied to a plurality of installed rhodium measuring devices, so that the rhodium measuring device may be continuously used even when sensitivity of the rhodium measuring device becomes less than or equal to ⅓ of initial sensitivity (⅔ or more of rhodium is burned up).

### Technical Solution

To achieve the above object, according to an aspect of the present invention, a first invention relates to a method for extending lifespans of rhodium measuring devices, which are arranged in a height direction of a nuclear fuel assembly so as to measure neutrons of a nuclear fuel in a nuclear reactor, the method including: measuring current signals expressed in amperes and induced by electrons emitted as rhodium in each of the rhodium measuring devices absorbs neutrons so as to undergo beta decay (S10); calculating positional power values of individual rhodium measuring devices for each rhodium burnup by using a CECOR program based on the current signals measured by the rhodium measuring devices, respectively (S20); calculating an optimal power value for all positions of the rhodium measuring devices for each rhodium burnup by dividing a sum of power values of all the rhodium measuring devices for each position in the height direction, which is calculated by the CECOR program, by a sum of positional power values of all the rhodium measuring devices for each position in the height direction, which is calculated by a design program, and multiplying a result of the division by a power value of each of the rhodium measuring devices for each corresponding position in the height direction, which is calculated by the design program (S30); determining a W′ correction constant or a change in an exponent of an approximate expression of sensitivity of the rhodium measuring devices according to an increase in an accumulated charge amount of the rhodium measuring devices based on the calculated optimal power value for all the positions of the rhodium measuring devices for each rhodium burnup (S40); calculating positional power values of the individual rhodium measuring devices for each rhodium burnup by using the determined W′ correction constant and the determined exponent of the approximate expression of the sensitivity of the rhodium measuring devices in each corresponding position, and checking the calculated positional power values of the individual rhodium measuring devices for each rhodium burnup by performing comparative analysis between the calculated positional power values of the individual rhodium measuring devices for each rhodium burnup and the positional power values of the rhodium measuring devices calculated in the step S20 (S50); and extending lifespans of usage of the rhodium measuring devices by applying the W′ correction constant or the exponent of the approximate expression of the sensitivity at a time point when ⅔ or more of the rhodium in the rhodium measuring devices is burned up (S60).

According to a second invention, in the first invention, the optimal power value for all the positions of the rhodium measuring devices in the step S30 may be calculated by Formula 1:

$${P}_{m}^{i} ( l ) = {P}_{d}^{i} ( l ) \frac{{\sum }_{i = 1}^{n} {P}_{c}^{i} ( l )}{{\sum }_{i = 1}^{n} {P}_{d}^{i} ( l )}$$

where Pⁱₘ(l)=Calculated value of l^{th} level power of i measuring devices,

Pⁱ_{d}(l)=l^{th} level power of i measuring devices (value calculated by design code),

Pⁱ_{c}(l)=l^{th} level power of i measuring devices (value calculated by CECOR),

l is a height of a rhodium measuring device from Level-1 to Level-5,

i is a number of respective rhodium measuring devices present in a corresponding level,

Pⁱ_{d}(l) is a power value calculated by a design code at each position of a rhodium measuring device for each of five levels, and

Pⁱ_{c}(l) is a power value calculated by CECOR at each position of a rhodium measuring device for each of five levels.

According to a third invention, in the second invention, the exponent of the approximate expression of the sensitivity of the rhodium measuring devices in the step S40 may be a sensitivity approximate expression exponent (α) calculated by reflecting the power value in the step S30 in Formula 2, and the W′ correction constant (W′_{CF}) may be determined by deriving the W′ correction constant (W′_{CF}) from Formula 3 as Formula 4 by using the sensitivity approximate expression exponent (α) in Formula 2, Formula 2 may be expressed as:

$$α = \frac{log ( \frac{I \cdot C \cdot {W}^{′}}{{P}_{m} {S}_{0}} )}{log ( 1 - \frac{Q ( t )}{{Q}_{∞}} )}$$

where S₀ and Q_{∞} are values provided by a rhodium measuring device manufacturer,

C and W′ are values generated during a design process,

Q(t) is a value measured for all rhodium measuring devices so as to be recorded and stored continuously over time in a power plant computer,

I is a current signal, which is a value continuously measured over time so that I actually signifies I(t), and Pₘ is a power value reflected from Formula 1, Formula 3 may be expressed as:

$${W}^{′} = \frac{{P}_{m} {S}_{0} ( 1 - \frac{Q ( t )}{{Q}_{∞}} )}{I \cdot C} ,$$

and Formula 4 may be expressed as:

$${W}_{CF}^{′} = \frac{{W}_{c}^{′}}{{W}_{d}^{′}}$$

where W′_{CF} is a value obtained by calculating W′ again by inducing Pₘⁱ(l) through Formula 1 while maintaining an exponent (α) at 1.0 as in a conventional scheme in Formula 3, and comparing the calculated W′ with W′ calculated in a current design,

W′_{c} is W′ that is newly adjusted according to Formula 3 based on Pₘⁱ(l) obtained through Formula 1 by setting an exponent (α) to 1.0 in Formula 3, and

W′d is W′ determined at a design stage.

According to a fourth invention, in the third invention, in the step S60, the exponent of the approximate expression of the sensitivity in Formula 2 may be applied to the sensitivity by Formula 5 so as to be used in the rhodium measuring devices, and the W′ correction constant in Formula 4 may be applied to Formula 6 so as to extend the lifespans of the usage of the rhodium measuring devices, Formula 5 may be expressed as:

$$S ( t ) = {{S}_{0} ( 1 - \frac{Q ( t )}{{Q}_{∞}} )}^{α}$$

where S(t) is sensitivity that decreases over time,

S₀ is initial sensitivity,

Q(t) is an accumulated charge amount of a generated current signal, and

Q_{∞} is an accumulated charge amount generated until rhodium is completely burned up, and Formula 6 may be expressed as:

$${P}_{m} = \frac{I}{S} \cdot C \cdot {W}^{′} \cdot {W}_{CF}^{′}$$

where Pₘ is a measured power value,

I is a current signal,

S is sensitivity of a measuring device,

C is a conversion constant,

W′ is W′ determined at a design stage, and

W′_{CF} derived from Formula 4 is a W′ correction constant.

### Advantageous Effects

According to the method for extending the lifespans of the rhodium measuring devices of the present invention, a replacement quantity of rhodium measuring devices replaced every cycles of each power plant can be reduced so as to reduce a replacement cost corresponding to tens of millions of won per unit.

In addition, manpower and a time required to replace a rhodium measuring device can be reduced.

In addition, the number of rhodium measuring devices being replaced can be reduced so as to reduce an amount of radioactive waste generated by disposal of a measuring device that has reached an end of a lifespan.

### DESCRIPTION OF THE DRAWINGS

FIG. 1 is a flowchart showing a method for extending lifespans of rhodium measuring devices according to the present invention.

FIG. 2 is a configuration diagram showing an arrangement of a nuclear fuel assembly loaded in a nuclear reactor and a rhodium measuring device installed inside the nuclear fuel assembly.

FIG. 3 is a view showing a section shape of a rhodium measuring device bundle taken from FIG. 2.

FIG. 4 is a view showing an exponent of an approximate expression of sensitivity of rhodium measuring devices, which is derived according to the implementation of the present invention, according to an accumulated charge amount of the rhodium measuring devices.

FIG. 5 is a view showing an average value of exponents of the approximate expression of the sensitivity of FIG. 4, which is calculated by dividing the accumulated charge amount by 10 coulombs.

FIG. 6 is a view showing a W′ correction constant, which is derived according to the implementation of the present invention, according to the accumulated charge amount of the rhodium measuring devices.

FIG. 7 is a view showing an average value of W′ correction constants of FIG. 6, which is calculated by dividing the accumulated charge amount by 10 coulombs.

### MODE FOR INVENTION

The following objects, other objects, features, and advantages of the present invention will be readily understood through the following preferred embodiments in conjunction with the accompanying drawings. However, the present invention is not limited to the embodiments described herein, but may be embodied in other forms.

Rather, the embodiments introduced herein are provided so that the disclosed contents may become thorough and complete, and the idea of the present invention may be sufficiently delivered to those skilled in the art.

The embodiments described and illustrated herein include their complementary embodiments.

In the present specification, unless the context explicitly dictates otherwise, expressions in a singular form include a meaning of a plural form. The term ‘comprise’ and/or ‘comprising’ used herein does not preclude the presence or addition of one or more other elements.

Hereinafter, the present invention will be described in detail with reference to the drawings. In describing the following specific embodiments, various specific details have been prepared to more specifically describe the invention and help understanding. However, it will be appreciated by a reader having enough knowledge in the art to understand the present invention that the present invention can be used without these various specific details. In some cases, it is mentioned in advance that parts that are commonly known and not highly relevant to the invention in describing the invention are not described in order to avoid confusion in describing the invention.

Hereinafter, a method for extending lifespans of rhodium measuring devices according to the present invention will be described in detail with reference to the accompanying drawings.

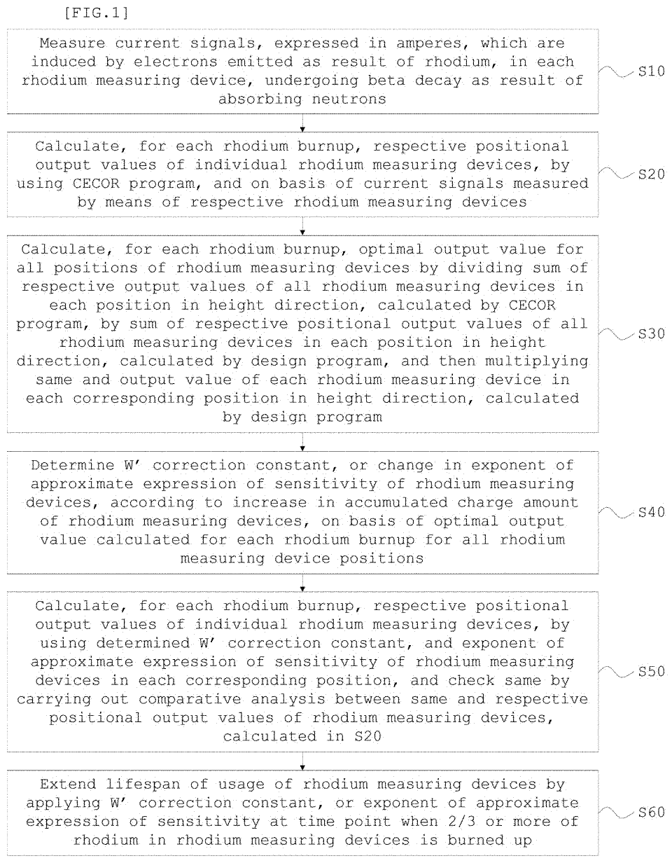

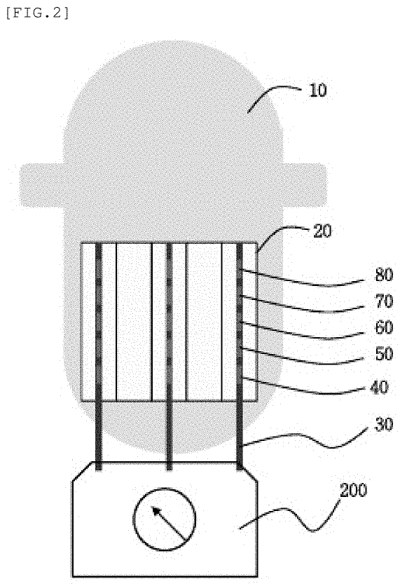

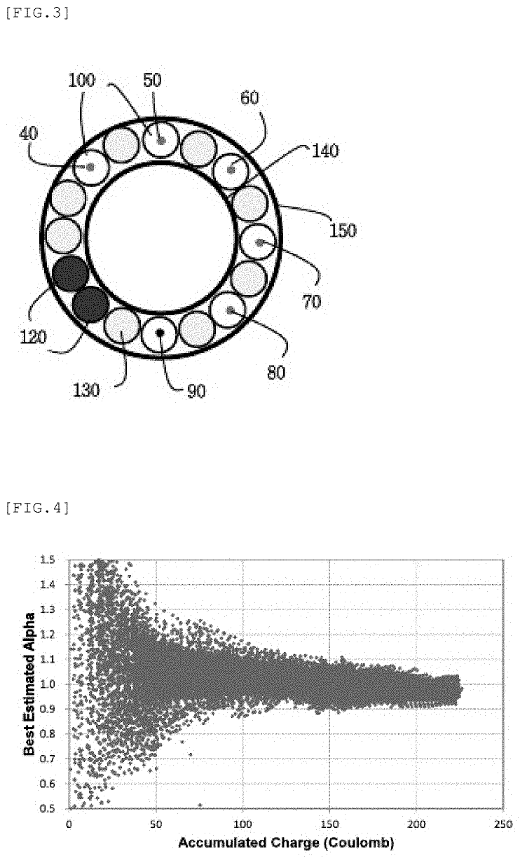

FIG. 1 is a flowchart showing a method for extending lifespans of rhodium measuring devices according to the present invention, FIG. 2 is a configuration diagram showing an arrangement of a nuclear fuel assembly loaded in a nuclear reactor and a rhodium measuring device installed inside the nuclear fuel assembly, and FIG. 3 is a view showing a section shape of a rhodium measuring device bundle taken from FIG. 2.

As shown in FIG. 1, the present invention relates to a method for extending lifespans of rhodium measuring devices, which are arranged in a height direction of a nuclear fuel assembly so as to measure neutrons of a nuclear fuel in a nuclear reactor, in which a change in a W′ correction constant or a change in an exponent of an approximate expression of sensitivity according to an increase in an accumulated charge amount is subject to tracking calculation so as to be individually applied to the rhodium measuring devices, so that the rhodium measuring device may be continuously used even when sensitivity of the rhodium measuring device becomes less than or equal to ⅓ of initial sensitivity (⅔ or more of rhodium is burned up).

In a step S10, current signals expressed in amperes and induced by electrons emitted as rhodium in each of the rhodium measuring devices absorbs neutrons so as to undergo beta decay may be measured.

In this case, when the rhodium of the rhodium measuring device absorbs the neutrons, the electrons may be generated through a nuclear reaction expressed by Formula 1a:

Rh₄₅¹⁰³+n→Rh₄₅¹⁰⁴→Pd₄₆¹⁰⁴+β⁻.

In this case, Rh₄₅¹⁰³, n, Pd₄₆¹⁰⁴, and β⁻ represent rhodium, neutron, palladium, and electron, respectively. When the rhodium present in the rhodium measuring device absorbs the neutrons, the rhodium may be first converted to Rh₄⁵¹⁰⁴, and since this isotope is unstable, the isotope may undergo beta decay at some time interval so as to be nuclear-transformed into Pd₄₆¹⁰⁴ and to emit the electrons.

The emitted electrons may induce a current signal in amperes, and since a larger current signal is generated as an amount of the neutrons increases, the amount of the neutrons may be measured by using this principle.

FIG. 2 shows the rhodium measuring devices installed inside the nuclear reactor, in which a nuclear fuel assembly 20 may be loaded in a reactor vessel 10, a rhodium measuring device bundle 30 may be inserted into a central hole of about ¼ of the nuclear fuel assembly that is selected, and one rhodium measuring device bundle may include five rhodium measuring devices 40, 50, 60, 70, and 80 having a length of 40 centimeters to measure a current signal that is proportional to an amount of neutrons at a corresponding position for each height in an axial direction of the nuclear fuel assembly and to store a result of the measurement in a power plant computer 200.

Referring to the section shape of the rhodium measuring device bundle of FIG. 3, the five rhodium measuring devices 40, 50, 60, 70, and 80 may be installed at positions in the axial direction, respectively, a background measuring device 90 for correcting a current caused by electrons generated by gamma rays rather than the neutrons may be installed, a thermocouple 120 for measuring a coolant temperature may be installed, a filler cable 130 for fixing a gap between the above components may be installed, and the above entire configuration may be fixed by a central pipe 140 and an outer pipe 150.

In other words, the length of the rhodium measuring device arranged for each height in the axial direction may be 40 centimeters, and the rhodium measuring devices may be classified into Level-1, Level-2, Level-3, Level-4, and Level-5 from a bottom to a top, respectively. Since a power of the nuclear fuel assembly for each height has a cosine shape with a small power at the bottom and the top and a large power at a center, powers of Level-2, Level-3, and Level-4 may be high, and powers of Level-1 and Level-5 may be relatively low.

A total length of the rhodium measuring device bundle may be about 40 meters, in which the rhodium measuring device bundle may be inserted into the nuclear fuel assembly through a guide tube from an outside of the nuclear reactor to measure the neutrons. The measured current signal may be continuously stored in the power plant computer, a power at a position of the rhodium measuring device may be calculated by retrieving information at a desired time point and using a CECOR program when necessary, and power distribution for an entire three-dimensional area may be calculated from a result of the calculation.

In a step S20, positional power values of individual rhodium measuring devices for each rhodium burnup may be calculated by using a CECOR program based on the current signals measured by the rhodium measuring devices, respectively.

In this case, the positional power values of the rhodium measuring devices may be calculated in the CECOR program by Formula 1b:

$${P}_{C} = \frac{I}{S} \cdot C \cdot {W}^{′}$$

where P_{c}=Positional power of measuring device calculated by using CECOR program (MW),

I=Current signal in which background signal is corrected (mA or mV),

S=Sensitivity of rhodium measuring device at corresponding position,

C=Conversion constant, and

W′=Power-to-reaction rate conversion factor (power-to-activation conversion factor).

In this case, the power-to-reaction rate conversion factor W′ may be calculated by using a reactor core design program (ROCS, ANC, or ASTRA, etc.) in a design stage by Formula 1c:

$${W}^{′} = \frac{Power}{\frac{1}{V} {\int }_{V} {\int }_{E} σϕ dEdV}$$

where Power=Assembly thermal power (MW),

V=Measuring device volume (cm³),

E=Neutron energy (eV),

σ=Rhodium neutron reaction cross section (cm²), and

Φ=Neutron flux (n/cm²-s).

In the above formula, the numerator represents an assembly thermal power (assembly power), and the denominator represents a reaction rate (activation). A value of the formula may be calculated in advance by using the reactor core design program for each nuclear fuel assembly and for each burnup, and the positional power of the measuring device may be calculated through the CECOR program by using the value together with the measured current signal as in Formula 1b.

In a step S30, an optimal power value for all positions of the rhodium measuring devices for each rhodium burnup may be calculated by dividing a sum of power values of all the rhodium measuring devices for each position in the height direction, which is calculated by the CECOR program in Formula 1b, by a sum of positional power values of all the rhodium measuring devices for each position in the height direction, which is calculated by a design program, and multiplying a result of the division by a power value of each of the rhodium measuring devices for each corresponding position in the height direction, which is calculated by the design program.

In the above step, the power of the rhodium measuring device at the corresponding position may be calculated by using a three-dimensional design code. However, although the power calculated by the design code generally corresponds to a case where the nuclear reactor operates at a power of 100%, an actual power of the nuclear reactor may gradually vary over time, so that a result of the calculation may not be directly applied. In particular, power distribution of an actual nuclear reactor in the axial direction may continuously oscillate up and down, and this phenomenon may not be accurately simulated with the design code. Therefore, the above problem may be solved by using Formula 1:

$${P}_{m}^{i} ( l ) = {P}_{d}^{i} ( l ) \frac{{\sum }_{i = 1}^{n} {P}_{c}^{i} ( l )}{{\sum }_{i = 1}^{n} {P}_{d}^{i} ( l )}$$

where Pⁱₘ(l)=Calculated value of l^{th} level power of i measuring devices,

Pⁱ_{d}(l)=l^{th} level power of i measuring devices (value calculated by design code), and

Pⁱ_{c}(l)=l^{th} level power of i measuring devices (value calculated by CECOR).

In the above formula, l represents a height of a rhodium measuring device from Level-1 to Level-5, and a superscript i represents respective rhodium measuring devices present in a corresponding level, which is 1 to 45 in a case of a Korean standard nuclear power plant (However, all faulty measuring devices may be excluded from the calculations of the denominator and the numerator). In addition, Pⁱ_{d}(l) represents a power calculated by a design code at each position of a rhodium measuring device for each of five levels, and Pⁱ_{c}(l) represents a power calculated by a code having a function of CECOR at each position of a rhodium measuring device for each of five levels.

Formula 1 may simulate an actual power state of the nuclear reactor as accurately as possible in calculating a power of the nuclear fuel assembly at a position where the measuring device is present for each level.

In a step S40, a W′ correction constant or a change in an exponent of an approximate expression of sensitivity of the rhodium measuring devices according to an increase in an accumulated charge amount of the rhodium measuring devices may be determined based on the calculated optimal power value for all the positions of the rhodium measuring devices for each rhodium burnup.

In this case, in the step S40, a sensitivity approximate expression exponent α may be calculated by reflecting the positional power of the rhodium measuring device, which is calculated by the design code and the CECOR program in the step S30, in Formula 2:

$$α = \frac{log ( \frac{I \cdot C \cdot {W}^{′}}{{P}_{m} {S}_{0}} )}{log ( 1 - \frac{Q ( t )}{{Q}_{∞}} )} .$$

In the above formula, S₀ and Q_{∞} are values provided by a rhodium measuring device manufacturer, and C and W′ are values generated during a design process. In addition, Q(t) is a value measured for all rhodium measuring devices so as to be recorded and stored continuously over time in a power plant computer. In this case, I is a current signal, which is a value continuously measured over time so that I actually signifies I(t), and Pₘ is a power value reflected from Formula 1.

In addition, a W′ correction constant W′_{CF} may be derived and determined from Formula 3 as Formula 4 by using the sensitivity approximate expression exponent α in Formula 2, in which Formula 3 may be expressed as:

$${W}^{′} = \frac{{P}_{m} {S}_{0} ( 1 - \frac{Q ( t )}{{Q}_{∞}} )}{I \cdot C}$$

where the W′ correction constant W′_{CF} is determined by calculating W′ again by inducing Pₘⁱ(l) through Formula 1 while maintaining an exponent α at 1.0 as in a conventional scheme in Formula 3, and comparing the calculated W′ with W′ calculated in a current design. In this case, the W′ correction constant W′_{CF} may be expressed as Formula 4:

$${W}_{CF}^{′} = \frac{{W}_{c}^{′}}{{W}_{d}^{′}}$$

where W′_{c} is W′ that is newly adjusted according to Formula 3 based on Pₘⁱ(l) obtained through Formula 1 by setting an exponent α to 1.0 in Formula 3, and W′_{d} is W′ determined at a design stage.

In a step S50, positional power values of the individual rhodium measuring devices for each rhodium burnup may be calculated by using the determined W′ correction constant and the determined exponent of the approximate expression of the sensitivity of the rhodium measuring devices in each corresponding position, and the calculated positional power values of the individual rhodium measuring devices for each rhodium burnup may be checked by performing comparative analysis between the calculated positional power values of the individual rhodium measuring devices for each rhodium burnup and the positional power values of the rhodium measuring devices calculated in the step S20.

In a step S60, lifespans of usage of the rhodium measuring devices may be extended by applying the determined W′ correction constant or the determined exponent of the approximate expression of the sensitivity at a time point when ⅔ or more of the rhodium in the rhodium measuring devices is burned up. In addition, a process from the step S10 to the step S60 may be repeatedly performed for measuring device data that is additionally provided every operation cycle to expand statistical data and continuously extend the lifespans of the usage of the rhodium measuring devices.

In this case, the exponent of the approximate expression of the sensitivity in Formula 2 may be applied to the sensitivity by Formula 5 so as to be used in the rhodium measuring devices, in which Formula 5 may be expressed as:

$$S ( t ) = {{S}_{0} ( 1 - \frac{Q ( t )}{{Q}_{∞}} )}^{α} .$$

In the above formula, S(t) represents sensitivity that decreases over time, and S₀ is initial sensitivity. In addition, Q(t) is an accumulated charge amount of a generated current signal, and Q_{∞} is an accumulated charge amount generated until rhodium is completely burned up.

The initial sensitivity S₀ and an infinite charge amount Q_{∞} may be provided by the rhodium measuring device manufacturer, and a value of α may be the determined exponent of the approximate expression of the sensitivity applied at the time point when ⅔ or more of the rhodium in the rhodium measuring devices is burned up.

In addition, the W′ correction constant in Formula 4 may be applied to Formula 6 so as to extend the lifespans of the usage of the rhodium measuring devices, in which Formula 6 may be expressed as:

$${P}_{m} = \frac{I}{S} \cdot C \cdot {W}^{′} \cdot {W}_{CF}^{′}$$

where Pₘ, I, and S are a measured power value, a current signal in which a background is corrected, and sensitivity of a measuring device, respectively, C is a conversion constant, W′ is W′ determined at a design stage, and W′_{CF} is a W′ correction constant.

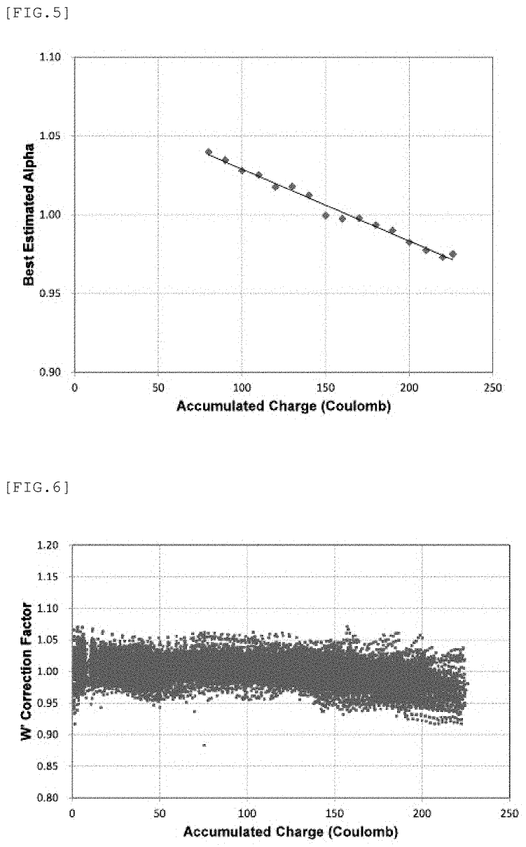

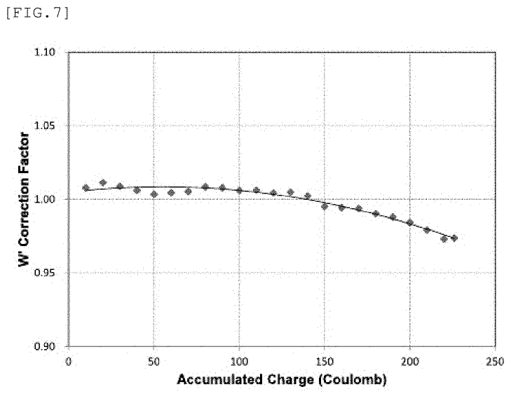

FIG. 4 is a view showing an exponent of an approximate expression of sensitivity of rhodium measuring devices, which is derived according to the implementation of the present invention, according to an accumulated charge amount of the rhodium measuring devices, FIG. 5 is a view showing an average value of exponents of the approximate expression of the sensitivity of FIG. 4, which is calculated by dividing the accumulated charge amount by 10 coulombs, FIG. 6 is a view showing a W′ correction constant, which is derived according to the implementation of the present invention, according to the accumulated charge amount of the rhodium measuring devices, and FIG. 7 is a view showing an average value of W′ correction constants of FIG. 6, which is calculated by dividing the accumulated charge amount by 10 coulombs.

FIG. 4 shows a result of analyzing the exponent of the approximate expression of the sensitivity according to the accumulated charge amount of the rhodium measuring devices, in which a very large dispersion is observed when the accumulated charge amount is less than or equal to 100 coulombs, and the exponent tends to decrease after being maintained near 1.0 when the accumulated charge amount is greater than or equal to 100 coulombs. The reason why there is no data for an accumulated charge amount of 220 coulombs or more in FIG. 4 is that all the rhodium measuring devices are replaced at this time point.

FIG. 5 shows a result of calculating the average value of the exponents of the approximate expression of the sensitivity of FIG. 4 by dividing the accumulated charge amount by 10 coulombs, and adding a linear trend line, in which the exponent of the approximate expression of the sensitivity gradually decreases as the accumulated charge amount increases, and the average value is predicted to be about 0.96 at an accumulated charge amount of 250 coulombs.

FIG. 7 shows a result of calculating the average value of the W′ correction constants of FIG. 6 by dividing the accumulated charge amount by 10 coulombs together with a quadratic function trend line, in which the average values are maintained near 1.0 up to an accumulated charge amount of 170 coulombs and gradually decreased from the accumulated charge amount of 170 coulombs or more, and the average value is predicted to be about 0.96 at an accumulated charge amount of 250 coulombs. Therefore, when the W′ calculated in the current design at the design stage up to the accumulated charge amount of 170 coulombs, and the W′ correction constant W′_{CF} is used from the accumulated charge amount of 170 coulombs or more, it may be expected that the power distribution is calculated more accurately, the lifespans of the usage of the measuring devices are extended.

The embodiments described herein and the configurations depicted in the drawings are only most preferred one embodiment of the present invention, and do not represent all of the technical ideas of the present invention, so it should be understood that various equivalents and modifications may be substituted for the embodiments and the configurations at the time of filing of the present application.

1. A method for extending lifespans of rhodium measuring devices, which are arranged in a height direction of a nuclear fuel assembly so as to measure neutrons of a nuclear fuel in a nuclear reactor, the method comprising:
measuring current signals expressed in amperes and induced by electrons emitted as rhodium in each of the rhodium measuring devices absorbs neutrons so as to undergo beta decay (S10);
calculating positional power values of individual rhodium measuring devices for each rhodium burnup by using a CECOR program based on the current signals measured by the rhodium measuring devices, respectively (S20);
calculating an optimal power value for all positions of the rhodium measuring devices for each rhodium burnup by dividing a sum of power values of all the rhodium measuring devices for each position in the height direction, which is calculated by the CECOR program, by a sum of positional power values of all the rhodium measuring devices for each position in the height direction, which is calculated by a design program, and multiplying a result of the division by a power value of each of the rhodium measuring devices for each corresponding position in the height direction, which is calculated by the design program (S30);
determining a W′ correction constant or a change in an exponent of an approximate expression of sensitivity of the rhodium measuring devices according to an increase in an accumulated charge amount of the rhodium measuring devices based on the calculated optimal power value for all the positions of the rhodium measuring devices for each rhodium burnup (S40);
calculating positional power values of the individual rhodium measuring devices for each rhodium burnup by using the determined W′ correction constant and the determined exponent of the approximate expression of the sensitivity of the rhodium measuring devices in each corresponding position, and checking the calculated positional power values of the individual rhodium measuring devices for each rhodium burnup by performing comparative analysis between the calculated positional power values of the individual rhodium measuring devices for each rhodium burnup and the positional power values of the rhodium measuring devices calculated in the step S20 (S50); and
extending lifespans of usage of the rhodium measuring devices by applying the W′ correction constant or the exponent of the approximate expression of the sensitivity at a time point when ⅔ or more of the rhodium in the rhodium measuring devices is burned up (S60).

2. The method of claim 1, wherein the optimal power value for all the positions of the rhodium measuring devices in the step S30 is calculated by Formula 1:
$${P}_{m}^{i} ( l ) = {P}_{d}^{i} ( l ) \frac{{\sum }_{i = 1}^{n} {P}_{c}^{i} ( l )}{{\sum }_{i = 1}^{n} {P}_{d}^{i} ( l )}$$
where Pⁱₘ(l)=Calculated value of l^{th} level power of i measuring devices,
Pⁱ_{d}(l)=l^{th} level power of i measuring devices (value calculated by design code),
Pⁱ_{c}(l)=l^{th} level power of i measuring devices (value calculated by CECOR),
l is a height of a rhodium measuring device from Level-1 to Level-5,
i is a number of respective rhodium measuring devices present in a corresponding level,
Pⁱ_{d}(l) is a power value calculated by a design code at each position of a rhodium measuring device for each of five levels, and
Pⁱ_{c}(l) is a power value calculated by CECOR at each position of a rhodium measuring device for each of five levels.

3. The method of claim 2, wherein the exponent of the approximate expression of the sensitivity of the rhodium measuring devices in the step S40 is a sensitivity approximate expression exponent (α) calculated by reflecting the power value in the step S30 in Formula 2, and the W′ correction constant (W′_{CF}) is determined by deriving the W′ correction constant (W′_{CF}) from Formula 3 as Formula 4 by using the sensitivity approximate expression exponent (α) in Formula 2,
wherein Formula 2 is expressed as:
$$α = \frac{log ( \frac{I \cdot C \cdot {W}^{′}}{{P}_{m} {S}_{0}} )}{log ( 1 - \frac{Q ( t )}{{Q}_{∞}} )}$$
where S₀ and Q_{∞} are values provided by a rhodium measuring device manufacturer,
C and W′ are values generated during a design process,
Q(t) is a value measured for all rhodium measuring devices so as to be recorded and stored continuously over time in a power plant computer,
I is a current signal, which is a value continuously measured over time so that I actually signifies I(t), and
Pₘ is a power value reflected from Formula 1,
wherein Formula 3 is expressed as:
$${W}^{′} = \frac{{P}_{m} {S}_{0} ( 1 - \frac{Q ( t )}{{Q}_{∞}} )}{I \cdot C} ,$$
wherein Formula 4 is expressed as:
$${W}_{CF}^{′} = \frac{{W}_{c}^{′}}{{W}_{d}^{′}}$$
where W′_{CF} is a value obtained by calculating W′ again by inducing Pₘⁱ(l) through Formula 1 while maintaining an exponent (α) at 1.0 as in a conventional scheme in Formula 3, and comparing the calculated W′ with W′ calculated in a current design,
W′_{c} is W′ that is newly adjusted according to Formula 3 based on Pₘⁱ(l) obtained through Formula 1 by setting an exponent (α) to 1.0 in Formula 3, and
W′_{d} is W′ determined at a design stage.

4. The method of claim 3, wherein, in the step S60, the exponent of the approximate expression of the sensitivity in Formula 2 is applied to the sensitivity by Formula 5 so as to be used in the rhodium measuring devices, and the W′ correction constant in Formula 4 is applied to Formula 6 so as to extend the lifespans of the usage of the rhodium measuring devices,
wherein Formula 5 is expressed as:
$$S ( t ) = {{S}_{0} ( 1 - \frac{Q ( t )}{{Q}_{∞}} )}^{α}$$
where S(t) is sensitivity that decreases over time,
S₀ is initial sensitivity,
Q(t) is an accumulated charge amount of a generated current signal, and
Q_{∞} is an accumulated charge amount generated until rhodium is completely burned up, and
wherein Formula 6 is expressed as:
$${P}_{m} = \frac{I}{S} \cdot C \cdot {W}^{′} \cdot {W}_{CF}^{′}$$
where Pₘ is a measured power value,
I is a current signal,
S is sensitivity of a measuring device,
C is a conversion constant,
W′ is W′ determined at a design stage, and
W′_{CF} derived from Formula 4 is a W′ correction constant.
